(19) United States
(12) Patent Application Publication
(10) Pub. No.: US 2009/0272156 A1
(43) Pub. Date: Nov. 5, 2009

(54) LOCKING SYSTEM FOR A STOPPER INCORPORATED INTO THE TOP OF A FUEL TANK FILLER PIPE

(75) Inventor: Maurice Journee, Reilly (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: INERGY AUTOMOTIVE SYSTEMS RESEARCH (SOCIETE ANONYME), Bruxelles (BE)

(21) Appl. No.: 11/721,853

(22) PCT Filed: Dec. 15, 2005
(86) PCT No.: PCT/EP2005/056807

§ 371 Date: Sep. 4, 2007

(30) Foreign Application Priority Data
Dec. 16, 2004 (FR) 04.13431

(51) Int. Cl. B65D 55/14; E05B 35/00; E05B 65/12; B60K 15/04

(52) U.S. Cl. 70/158; 70/190; 70/344; 70/237

(57) ABSTRACT

A locking system for locking a stopper incorporated into the top of a fuel tank filler pipe, the stopper allowing the pipe to be opened automatically via action of a fuel dispensing nozzle. The stopper is retractable under action of a thrust directed against the stopper along an axis parallel to the axis of the top of the pipe, and is secured to a return spring that keeps the stopper in the closed position. The system includes a rotary ring configured to prevent movement of the stopper via a bayonet system, and rotary movement of which is brought about using a key.

The present invention relates to a locking system for a stopper incorporated into the top of a fuel tank filler pipe.

Filler pipes present on fuel tanks, particularly tanks on board motor vehicles, are plugged during normal use of the tank, outside of filling periods. Plugging is generally achieved by means of a cap inserted into the upper part of the pipe, by having a rotational movement imparted to it in order to seal the pipe against liquids and gases. Various types of cap may be encountered, made of metal and/or made of plastic, sealing being achieved by compressing a seal, this being achieved by screwing or by turning a key inserted into the middle of the part outside the pipe, the cap in this case often having still to be turned manually.

The operations of removing the cap before filling the tank and of replacing this cap and closing off the pipe after filling are usually done manually by the user or by the service station attendant dispensing the fuel. When the tank filling operation is over, the replacing of the cap is sometimes forgotten and this can then give rise to the loss of this cap and to the pipe being left open to the atmosphere for some length of time. During this period, losses of liquid fuel may occur and vapours escape into the ambient atmosphere.

With a view to avoiding cap losses and the ensuing atmospheric pollution, plugging devices built into the filler pipe have been proposed as a replacement for the conventional cap. Improved versions thereof generally comprise immobilizing means that prevent the said systems from being able to open unexpectedly, for example when the bowl (the depression in the bodywork in which the filler pipe is located and which is closed off by the fuel filler flap) is being cleaned using a pressure washer.

Thus, document EP 1 415 844 describes the (un)locking of a dust cover affixed over the top of an actual stopper using the ignition key, this being by means of a mechanism comprising a barrel and a lock bolt, which prevents the said dust cover from pivoting under the action of a filler nozzle. Such a system is actually well-suited to a dust cover but is not suitable for the actual stopper, which is subjected to greater mechanical stresses.

Furthermore, application WO 03/010022 in the name of the Applicant Company describes a bayonet system (notched rotary ring and panel with lugs) the (un)locking of which is tied to that of the fuel filler flap via a linkage and a system of springs. Such a system does actually ensure that the stopper is correctly locked when the fuel filler flap is closed. However, it presents the risk that a high pressure water jet directed substantially parallel to the axis of the top of the pipe could, in spite of everything, disengage the immobilizing means in the same way as a filler nozzle would. Furthermore, the particular system illustrated in that application (a bayonet system including a hairpin spring, a linkage, a rotary collar, two springs, etc.) is complicated.

The present invention aims to provide a system that is distinctly simpler and offers the same advantage of secure locking while at the same time allowing the top of the pipe to be cleaned in complete safety also. This system benefits from the rotary movement imparted to a key in order to directly (un)lock a system locked using a likewise rotary part.

To this end, the present invention relates to a locking system for locking a stopper incorporated into the top of a fuel tank filler pipe, this stopper allowing the pipe to be opened automatically via the action of a fuel dispensing nozzle and being:
retractable under the action of a thrust directed against it along an axis parallel to the axis of the top of the pipe;
secured to a return spring that keeps it in the closed position;
   the said system comprising a rotary ring able to prevent the movement of the stopper via a bayonet system and the rotary movement of which is brought about using a key.

The term “fuel tank” is intended to denote any type of tank capable of storing a liquid and/or gaseous fuel under varying temperature and pressure conditions. Those more particularly concerned are tanks of the kind found in motor vehicles. The expression “motor vehicle” is intended to include motor cars, motorcycles and trucks.

The filler pipe is a pipe which communicates with the inside of the tank and allows fuel to be introduced.

The tank and the pipe may be made of metal or of plastic.

The plugging system according to the invention is well-suited to a tank and filler pipe assembly in which at least one of the two components of the assembly is made of plastic. It is particularly well-suited to an assembly in which the filler pipe is made of plastic. As a preference, this plugging system itself comprises at least one part made of plastic. As a quite particular preference, it is mainly made of plastic.

The term “plastic” is intended to denote any material comprising at least one synthetic resin polymer.

All types of plastic may be suitable. Particularly suitable plastics come from the thermoplastics category.

The term “thermoplastic” denotes any thermoplastic polymer, including thermoplastic elastomers, as well as blends thereof. The term “polymer” denotes both homopolymers and copolymers (especially binary or ternary copolymers). Examples of such copolymers are, nonlimitingly, random copolymers, linear block copolymers, other block copolymers and graft copolymers.

Any type of thermoplastic polymer or copolymer whose melting point is below the decomposition temperature is suitable. Synthetic thermoplastics that have a melting range spread over at least 10 degrees Celsius are particularly suitable. Examples of such materials include those that exhibit polydispersion in their molecular weight.

In particular, polyolefins, polyvinyl halides, thermoplastic polyesters, polyketones, polyamides and copolymers thereof may be used. A blend of polymers or copolymers may also be used, as may a blend of polymer materials with inorganic, organic and/or natural fillers such as, for example, but nonlimitingly, carbon, salts and other inorganic derivatives, natural fibres or polymeric fibres. In particular, fibre-filled (for example glass-fibre-filled) polyamides are particularly suitable. Advantageously, at least some of these polymeric materials contain a conductive filler (carbon black, for example) in order to avoid problems associated with static electricity. It is also possible to use multilayer structures consisting of stacked layers bonded together comprising at least one of the polymers or copolymers described above.

The plugging system at which the invention is aimed is intended to act as a cap which seals the upper part of the filler pipe, outside periods when the tank is being filled, with a view to avoiding any release and loss of liquid fuel and vapour into the atmosphere when the tanks contains fuel.

This plugging system according to the invention is incorporated into the top of the filler pipe, that is to say is incorporated into a set of parts which are mounted on the upper end of the filler pipe and the purpose of which is to guide a fuel dispensing nozzle and make filling easier. To do this, the top of the pipe comprises an opening communicating with (in the continuation of) the filler pipe and that the stopper of the system according to the invention is able to close off in a sealed manner when in the closed (locked) position.

The plugging system according to the invention in particular allows the pipe to be opened automatically via the action of the filler nozzle. The expression “opened automatically” is to be understood as meaning opening performed simply under the action of the dispensing nozzle, to the exclusion of any other mechanical influence. The dispensing nozzle is the one fitted to the fuel pump hoses in service stations.

The plugging system comprises a stopper, that is to say a device that closes off the passage to gases and liquids through the aforementioned opening in the top of the pipe. This stopper may adopt various forms. One particularly suitable form is that of a moving plate which plugs the passage when in the closed position. As a preference, this plate pivots about an axis. It is advantageously made of plastic but is preferably equipped with a metal cover, particularly for aesthetic reasons and for resistance to abrasion (wear following numerous insertions of filler nozzles).

This plate may possibly be coupled to a rotary plug comprising a cylindrical opening (as in application FR 03/12782 in the name of the Applicant Company, the content of which is therefore incorporated by reference into this application).

This plate may also comprise a device for regulating the pressure in the filler pipe and, in particular, an “SPD” (for “safety under pressure and depression”) valve as described in application FR 2 753 138, the content of which is also incorporated by reference into this application.

According to the invention, the stopper can retract under the action of a thrust directed against it along an axis parallel to the axis of the top of the pipe. Various means may be present to render the stopper retractable. One means that has yielded good results is a rod secured to the top of the pipe and situated at the periphery of the stopper and which can act as a rotation axle allowing the stopper to pivot.

The stopper is kept in a closed position by a return spring. One type of spring that is particularly suitable is a torsion spring positioned around the rod and one end of which is secured to the stopper.

The stopper can present a conical shape on the part suitable to cooperate, when the stopper is in closed position, with the periphery of the opening in the top of the pipe. In general, the conical geometry allows a reduction of the stopper closing force and the use of less powerful springs.

According to the invention, the stopper is secured to a rotary ring by a bayonet system of which the collaborating parts are preferably positioned on the ring (preferably on the interior cylindrical surface thereof) or on the stopper (preferably on its exterior periphery). These parts of the bayonet device need to have a geometry such that the ring can turn between the positions in which the bayonet is locked and unlocked. Thus, for example, one part (for example, the ring) may comprise recesses of a size and shape suitable for allowing the lugs positioned on the other part (the stopper) to move and to pass.

In particular, the recesses in the ring (or in the stopper) advantageously comprise a circular or helical ramp and notches in a number corresponding to the number of lugs positioned on the stopper (or on the ring).

In general, in order to achieve satisfactory mechanical strength, it is preferably to have at least two, preferably at least three or even at least four lugs/notches (in order to spread the load when stressed).

The variant whereby the stopper bears the lugs and the ring bears the recesses is preferred. Note, for example, that existing tops of pipes may in this way easily be equipped with a device according to the invention. Indeed, all that is required is for the existing stopper to be provided with a shield bearing lugs, for a seal to be inserted between this shield and the top of the pipe and for a moving ring with recesses as described hereinabove to be fixed over the top of all of this.

In such systems, when the bayonet is in the locked position, the recesses are engaged in the ramp and immobilize the stopper (thrust along the axis not allowing it to pivot). When the bayonet is opened, the ring is given a rotary movement, which causes the lugs to travel along the ramp (or vice versa, since the lugs are, in fact, stationary) until they reach the notches made in the ramp for that purpose and thus allow the stopper to pivot.

It should be noted that, according to the invention, the movement of the ring may be either a pure rotational movement about an axis (preferably the axis of the stopper) or helical movement which is in fact a combination of a rotation about an axis (for example, describing at least ⅛, or even ⅙ and preferably at least ¼ of a turn (this fraction being, in fact, dependent on the number of lugs)) and of a translational movement parallel to this axis (for example, of the order of some 1/10 of an mm, or even of 1 mm, this being dependent on the nature of the seal (in order for it to be compressed enough to provide the desired level of sealing)). According to the invention, it is important for at least part of this movement to be a rotational movement brought about directly by the action of a key.

In the system according to the invention it is possible to envisage the presence of a seal affixed between the stopper and the top of the pipe or, more precisely, around the periphery of the opening that the stopper is supposed to plug. The aforementioned ring movement is then preferably a helical movement which respectively compresses this seal when the bayonet is closed and decompresses the said seal when it is opened. This seal may be of any kind. A seal of the O-ring type yields good results. The material of which this seal is made will preferably be chosen such that it is resistant to fuel vapours. Fluorinated elastomers are particularly suitable for this.

In the case where the stopper presents a part with a conical shape profile, the sealing between this profile and the profile of the periphery of the opening that the stopper aims at closing, can be made by a seal with an adapted geometry, for example a spindle seal.

Finally, in the system according to the invention, the rotational movement of the key needs to be transmitted to the rotary ring. This is preferably done simply by using at least one mechanical link. An example of such a link is the one where the key is inserted into a barrel, which turns a set of gears secured to the ring of the bayonet fitting.

In this case, the system according to the invention comprises a barrel which, when turned using a key, instigates the rotation of a set of gears which in turn turns the ring and (un)locks the bayonet. To do this, the barrel is generally equipped with a slot the size and shape of the key. Turning the key by a quarter of a turn for example unlocks the bayonet, which then allows the stopper to pivot. When the bayonet is in the unlocked position it is preferably (in such a system) impossible to remove the key from the barrel. The key cannot be removed from the barrel until, by being turned a quarter of a turn in the opposite direction using the key, the bayonet is locked Note that any type of mechanical link known in the field of locks may be suitable.

In the system according to the invention, whatever the mechanical link used, it is advantageous for it to comprise a slot into which the key is inserted and for it to be impossible to remove the key from this slot when the bayonet is in the unlocked position. This key cannot be removed from the slot until the bayonet is locked.

The present invention also relates to a motor vehicle fuel tank equipped with a system as described hereinabove. Such a tank comprises:
a filler pipe provided with a top
a stopper incorporated into this top and allowing the pipe to be opened automatically via the action of a fuel dispensing nozzle
a rotary ring able to prevent the movement of the stopper via a bayonet system and the rotary movement of which is brought about using a key
   the top of the pipe further comprising a device allowing a rotational movement of the key to be transmitted to the rotary ring in order to (un)lock the bayonet.

The present invention finally relates to a motor vehicle equipped with a plugging system as described hereinabove.

In this case, advantageously, the key for (un)locking the bayonet is the vehicle ignition key.

Furthermore, as explained hereinabove, it is advantageous for it to be impossible to detach (remove) the key from the system according to the invention when the bayonet is in the unlocked position. Such a device makes for more secure access to the filling orifice of the top of the pipe in a simple way (using the vehicle main key) while at the same time guaranteeing that the vehicle cannot be restarted without the top of the pipe being locked and secured (acting as an anti-theft cap).

For preference, this vehicle is provided with a monitoring sensor (a luminous or audible indicator) that checks that the plugging system has been correctly locked, this sensor preferably being situated near the top of the pipe, to improve safety (in particular, to prevent someone not starting the vehicle directly after filling the tank from forgetting to lock the plugging system).

This sensor may advantageously be incorporated into the tank filling bowl (or part secured to the top of the pipe and situated under the fuel filler flap). This variant is particularly advantageous when the fuel filler flap is tied in with the central locking system (that operates the doors, the bonnet, the boot, etc.) of the vehicle. Indeed, this then in particular prevents the said sensor from being damaged by an act of vandalism when the vehicle is stationary and locked.

1-10. (canceled)

11. A locking system for locking a stopper incorporated into the top of a fuel tank filler pipe, the stopper allowing the pipe to be opened automatically via action of a fuel dispensing nozzle and being:
retractable under action of a thrust directed against the stopper along an axis parallel to the axis of the top of the pipe; and
secured to a return spring that keeps the stopper in a closed position;
the system comprising a rotary ring configured to prevent movement of the stopper via a bayonet system, and rotary movement of which is brought about using a key.

12. A system according to claim 11, wherein active parts of the bayonet system include recesses and lugs that complement each other, one type of active part located on the ring and the other on the stopper.

13. A system according to claim 12, wherein the stopper bears the lugs and the ring bears the recesses.

14. A system according to claim 11, further comprising a barrel which, when turned using the key, instigates rotation of a set of gears, which in turn causes the ring to turn and unlock or lock the bayonet system.

15. A system according to claim 11, further comprising a slot into which the key is inserted, and wherein when the bayonet system is in an unlocked position, it is impossible to remove the key from the slot.

16. A motor vehicle fuel tank comprising:
a filler pipe provided with a top;
a stopper incorporated into the top and allowing the pipe to be opened automatically via action of a fuel dispensing nozzle;
a rotary ring configured to prevent movement of the stopper via bayonet system, and rotary movement of which is brought about using a key;
wherein the top of the pipe further comprises a device allowing a rotational movement of the key to be transmitted to the rotary ring to unlock or lock the bayonet system.

17. A motor vehicle equipped with a system according to claim 16, wherein the key for unlocking and locking the bayonet system is the vehicle ignition key.

18. A vehicle according to claim 17, further comprising a sensor for monitoring that the bayonet system is correctly locked, the sensor being positioned near the top of the pipe.

19. A vehicle according to claim 18, wherein the sensor is incorporated into a tank filling bowl secured to the top of the pipe and situated under a fuel filler flap.

20. A vehicle according to claim 19, wherein the fuel filler flap is tied in to the vehicle central locking system.
